(19) United States
(12) Patent Application Publication
(10) Pub. No.: US 2010/0121713 A1
(43) Pub. Date: May 13, 2010

(54) System and Method for Advertising Information

(76) Inventor: Andrew Robert Cardoza, Stellenbosch (ZA)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 12/439,502

(22) PCT Filed: Apr. 26, 2007
(86) PCT No.: PCT/IB2007/051556

§ 371 Date: Dec. 7, 2009

(30) Foreign Application Priority Data
Aug. 28, 2006 (ZA) 2006/07173

(51) Int. Cl. G06Q 30/00

(52) U.S. Cl. 705/14.55

(57) ABSTRACT

A system for advertising information includes a database, a communications module and a server. To advertise a product for sale, an advertiser compiles an advertisement containing a brief description of the product and an additional piece of information on the product. The server receives a request from the advertiser to make the additional information available to the public and generates a unique code corresponding to the additional information. The code is then sent to the advertiser for insertion in an advertisement for the product and stored together with the additional information in the database. The server receives requests from potential purchasers to view the additional information, accompanied by the code and sends the potential purchasers the additional information and a further piece of information which is related to the advertisement according to a predetermined criterion and which is supplied by a different advertiser.

### RELATED APPLICATIONS

The present application is filed under 35 U.S.C. §371 as a national stage submission of International Application No. PCT/IB2007/051556, which has an international filing date of Apr. 26, 2007 and a priority date of Aug. 28, 2006 based on South African Provisional Patent Application 2006/07173. Accordingly, the present application claims a priority filing date of Aug. 28, 2006 pursuant to 35 U.S.C. §§119(a) and 365(b).

### TECHNICAL FIELD

The present system and method relates to advertising information. More particularly, the present exemplary system and method relate to transmitting advertising information to a mobile phone.

### BACKGROUND

Advertising is commonly carried out via many different communications channels. Television and radio advertising have historically been successful mediums for advertising. However, many people are now becoming more dependent on wireless technology to receive news, entertainment, and advertisements. Typically, advertisements are configured to peak an observer's interest and create a desire for further information. Traditionally, this desire for additional information was only able to be satisfied by visiting or otherwise contacting a store associated with the advertisement.

Any reference herein to “advertise” must be interpreted to mean a reference to making any information (whether of a commercial nature or not) available to the public.

Similarly, any reference herein to an “advertisement” must be interpreted to mean a reference to any information (whether of a commercial nature or not) which is made available to the public.

Furthermore, any reference herein to an “advertiser” must be interpreted sufficiently broadly to mean a reference to a person or entity which makes any information (whether of a commercial nature or not) available to the public.

Any reference herein to “products” must be interpreted sufficiently broadly to refer to goods or services.

Any reference herein to “sale” or “sell” must be interpreted sufficiently broadly to include a reference to hire, lease, promote or the like.

### SUMMARY

According to a first exemplary embodiment, there is provided a method of advertising information, the method including: receiving a request from an advertiser wishing to advertise certain advertisement information, to make a particular additional piece of information which is associated with said advertisement information and which is supplied by the advertiser, available to the public; and issuing a unique reference code corresponding to the additional piece of information; storing the additional piece of information together with the unique reference code in a database; providing the advertiser with the unique reference code for insertion in an advertisement containing said advertisement information; receiving a request from an end user to view the additional piece of information, which is accompanied by the unique reference code corresponding to the additional piece of information; allowing the end user access to said additional piece of information; and providing the end user with a further piece of information which is related to said advertisement information according to a predetermined criterion, and which is supplied by the or a different advertiser.

The method may include, according to one exemplary embodiment, receiving requests from a number of different advertisers wishing to advertise different advertisement information, to make additional pieces of information available to the public, and issuing a unique reference code corresponding to each additional piece of information.

The exemplary method may include, upon receipt of a request from an end user to view a particular additional piece of information which is accompanied by the unique reference code corresponding to said additional piece of information, selecting at least one further piece according to said predetermined criterion and providing the end user with said further piece of information.

The exemplary method may further include classifying the additional pieces of information and the further pieces of information into different categories and storing each of the additional and the further pieces of information in the database in one of the categories and selecting at least one further piece of information from the same category in which the requested additional piece of information is stored, upon receipt of a request from an end user to view the additional piece of information.

In a particular exemplary embodiment wherein the advertisement information includes information on a particular product which the advertiser wishes to sell and wherein each additional piece of information includes additional information on the product, together with contact information sufficient to enable the advertiser to be contacted, the method may include receiving a request from an end user in the form of a potential purchaser of the product, to view the additional piece of information, which is accompanied by the unique reference code corresponding to the advertisement information; and if the product is still available for sale, sending the additional piece of information to the potential purchaser; and if the product is no longer available for sale, sending the potential purchaser at least one further piece of information on another product which is related to said product according to said predetermined criterion and which is offered for sale by the or another advertiser.

The present exemplary method may also include communicating with the advertiser and the end user via a mobile communications network.

The method may further include communicating with the advertiser and the end user by sending and receiving messages via a mobile telecommunications network.

According to a second exemplary embodiment of the exemplary system and method, there is provided a system for advertising information, including memory means in which information can be stored and processing means which is operable to:
a) receive a request from an advertiser wishing to advertise certain advertisement information, to make a particular additional piece of information which is associated with said advertisement information and which is supplied by the advertiser, available to the public; and to issue or generate a unique reference code corresponding to the additional piece of information;
b) store of the additional piece of information together with the unique reference code in the memory means;
c) provide the advertiser with the unique reference code for insertion in an advertisement containing said advertisement information;
d) receive a request from an end user to view the additional piece of information, which is accompanied by the unique reference code corresponding to the additional piece of information;
e) allow the end user access to said additional piece of information; and
f) provide the end user with a further piece of information which is related to said advertisement information according to a predetermined criterion and which is supplied by the or a different advertiser; and
   a communications module for communication with the advertiser and end user.

The processing means may be operable to receive requests from a number of different advertisers each wishing to advertise different advertisement information, to make different additional pieces of information available to the public and to issue a unique reference code corresponding to each additional piece of information.

The processing means may be operable to, upon receipt of a request from an end user to view a particular additional piece of information which is accompanied by the unique reference code corresponding to said additional piece of information, select at least one further piece of information of the or another advertiser according to said predetermined criterion and to provide the end user with said further piece of information.

The processing means may be operable to classify the additional piece of information and the further pieces of information into different categories and to store each of the additional and further pieces of information in the database in one of the categories and to select at least one further piece of information from the same category in which the requested additional piece of information is stored, upon receipt of a request from an end user to view the additional piece of information.

In a particular exemplary embodiment of the present system and method where the advertisement information of a particular advertiser includes information on a particular product which the advertiser wishes to sell and the associated additional piece of information includes additional information on the product, together with contact information sufficient to enable the advertiser to be contacted, the processing means may be operable to receive a request from an end user in the form of a potential purchaser of the product, to view the additional piece of information, which is accompanied by the unique reference code corresponding to the advertisement information; and if the product is still available for sale, to send the potential purchaser the additional piece of information; and if the product is no longer available for sale, to send the potential purchaser at least one further piece of information on another product which is related to said product according to said predetermined criterion and which is offered for sale by the or another advertiser.

The communications module may be operable to communicate with the advertiser and the end user via a mobile communications network.

The communications module may be operable to communicate with the advertiser and the end user by sending and receiving messages via a mobile telecommunications network.

### BRIEF DESCRIPTION OF THE DRAWINGS

Further features of the exemplary system and method are described hereinafter by way of a non-limiting example with reference to and as illustrated in the accompanying diagrammatic drawings. In the drawings:

FIG. 1 shows a schematic block diagram illustrating the operation of a system for advertising information according to one exemplary embodiment.

FIG. 2 shows a schematic block diagram of the system of FIG. 1 according to one exemplary embodiment.

FIG. 3 shows a schematic block diagram illustrating the operation of one embodiment of the system in accordance with according to one exemplary embodiment which is adapted for use in advertising products for sale.

FIG. 4 shows a schematic flow diagram illustrating a method of advertising products for sale according to one exemplary embodiment.

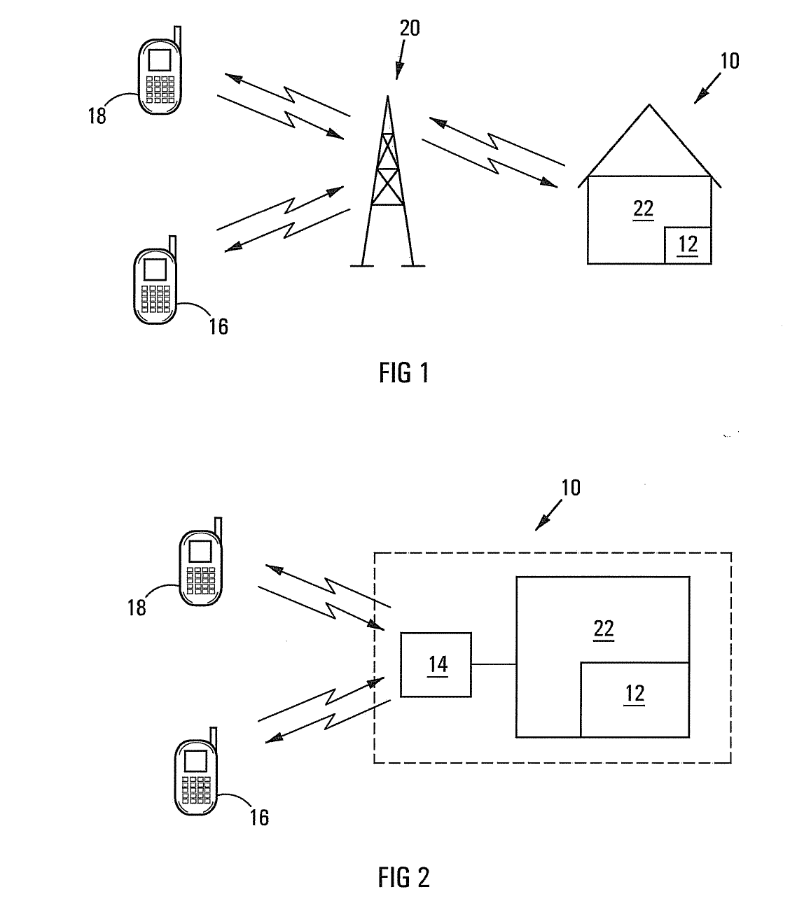

In the figures, identical reference numbers identify similar elements or acts. The sizes and relative positions of elements in the drawings are not necessarily drawn to scale.

### DETAILED DESCRIPTION

With reference to the drawings, one embodiment of a system for advertising information, in accordance with the present exemplary system and method is designated generally by the reference numeral 10. The system 10 includes memory means in the form of a database 12 in which information can be stored, a communications module 14 for communicating with a plurality of mobile telephones 16 operated by advertisers and a plurality mobile telephones 18 operated by potential purchasers via a mobile telecommunications network 20 and a server 22 including a processor (not shown) which is linked to the communications module 14 and to the database 12.

Advertisers wishing to make use of the system 10 to advertise products which they wish to sell will be required to register with the organization which operates the system.

In order to advertise a particular product for sale, the advertiser will compile an advertisement containing advertisement information in the form of a brief description of the product and an additional piece of information which is associated with the product and which typically includes a more comprehensive description of the product, together with the advertiser's contact details. Upon registration, the additional piece of information is sent to the organization to be stored on the database 12.

The system 10 is located at the site of the organization operating the system. The server 22 is operable to receive a request from the advertiser to register with the organization and to make the additional piece of information, available to the public. Upon receipt of the request from the advertiser, the server 22 generates a unique reference code corresponding to the additional piece of information. For example, an advertiser will send an SMS message containing the additional information which includes further details of the product which in this example is a motor vehicle which the advertiser wishes to offer for sale and the advertiser's contact details. The SMS message sent by the advertiser in this case reads: “1985 Land Rover Discovery V8i Automatic, 250,000 km, Yellow, phone Andrew 083 244 5454”. The product details contained in the message and the advertiser's contact details are stored in the database and a SMS message containing the unique reference number (e.g. “AA123Z”) for the advertisement is sent to the advertiser. The advertiser will then place an advertisement, for example, online, in local newspapers or on community bulletin boards containing advertisement information, including details of the motor vehicle and the unique reference number. For example, the advertisement typically reads: “1985 Land Rover, 250,000 km. Yellow. SMS AA123Z to 33090”. Potential purchasers will thus be invited to respond to the advertisement by sending a SMS message containing the unique reference number “AA123Z” to the service number “33090”.

The server 22 is operable to receive requests from end users (who are in this example, potential purchasers of the motor vehicle), accompanied by the unique reference number, for the additional piece of information. In response to a request received from a potential purchaser, the additional piece of information including the further details of the product and the advertiser's contact details, is sent via return SMS to the potential purchaser. It will be appreciated that the potential purchaser's contact telephone number will be known to the server via existing caller identity technology. If the advertiser does not wish to receive any further responses to the advertisement placed by him, for example, if the vehicle has been sold, the advertiser sends a SMS message “AA123Z close” to the server requesting that the advertisement be closed. The additional piece of information on the product will then not be forwarded to any further potential purchasers who respond to the advertisement placed by the advertiser.

The server 22 is operable to classify details of products received from advertisers into different categories and to store the details in the database in the different categories. As such, if an instruction is received from an advertiser that a particular product offered for sale by the advertiser is no longer available for sale, the server is operable to select at least one other related product in the same category in which details of the retracted product are stored and to send a SMS message containing a further piece of information which includes details of the related product, to potential purchasers who respond to the closed advertisement.

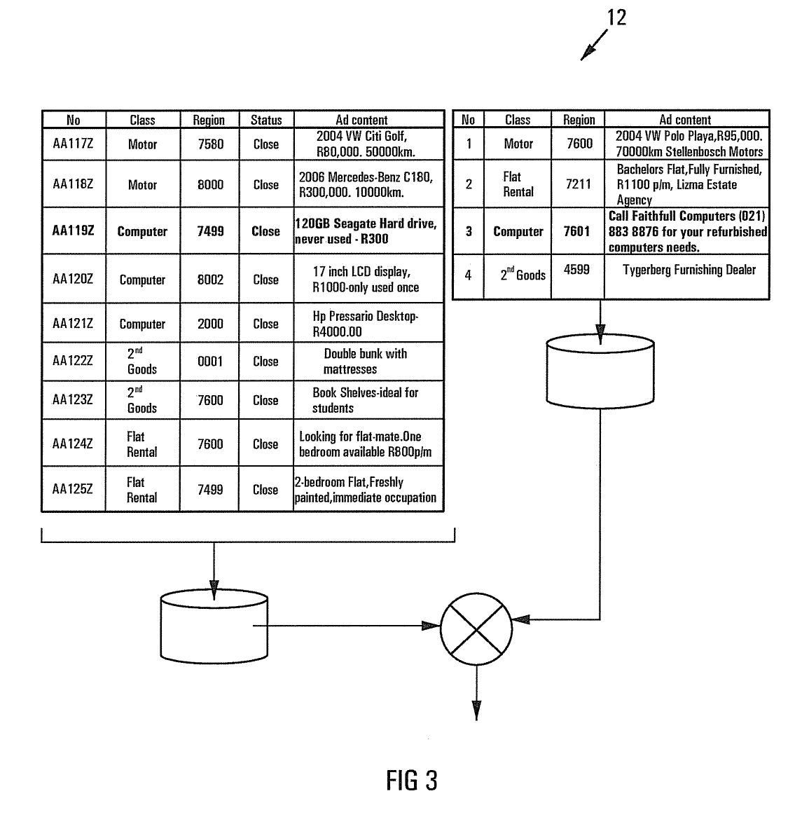

With reference to FIG. 3 of the drawings, an example of the process is illustrated. If an instruction is received, for example, from an advertiser of a computer hard drive, having the following details: “120 GB/Seagate Harddrive, never used—R300”, to close the advertisement, the status of the advertisement is changed from “open” to “closed”. Details of the computer hard drive are stored in the database 12 in the broad “computer” category.

Upon receipt of a response from a potential purchaser to the advertisement for the computer hard drive, the server is operable to search the database for other related products in the same computer category. The search is conducted using the keyword “computer” as the selection criterion. In this instance, details of a related computer product in the same category were found: “Call Faithful Computers 021 883 8876 for your refurbished computer needs”. The server 22 is operable to send the following SMS message to the potential purchaser: “The ad has been closed for viewing. Call Faithful Computers 021 883 8876 for your refurbished computer needs”. It will be appreciated that the server is operable to select other related products in the same category according to least one additional criterion which may be that advertisements for the retracted product and the related product must, for example, have been received from advertisers in the same geographical region. It will be appreciated that the criteria used in the selection of related products for sending to potential purchasers may vary greatly and that a number of criteria may be used to identify an appropriate related product which potential purchasers may be interested in.

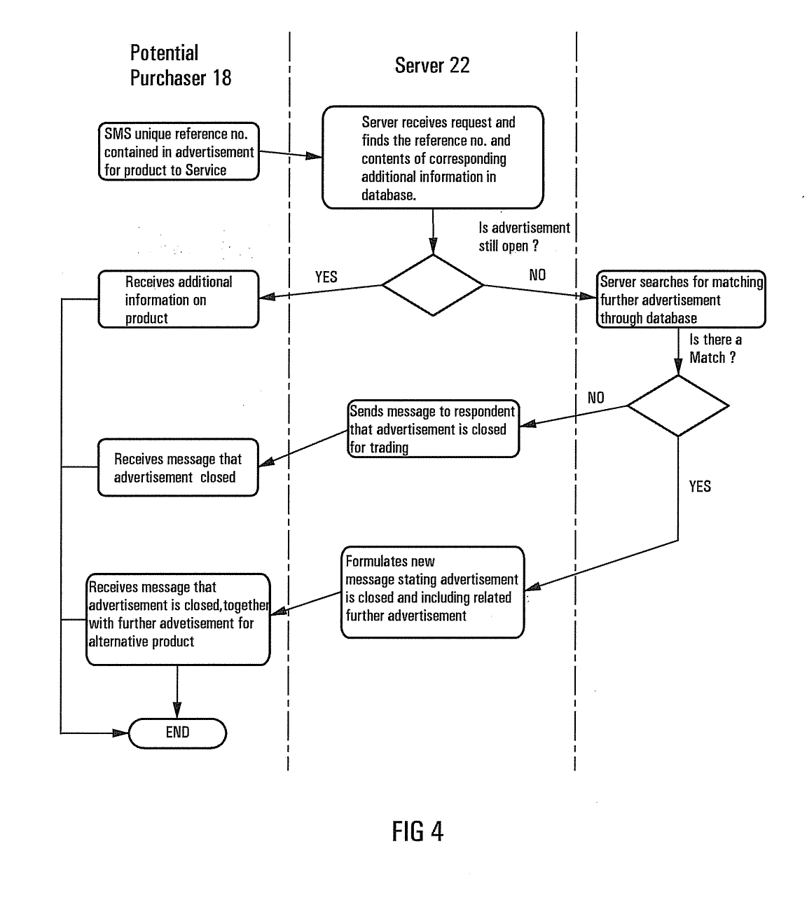

With reference to FIG. 4 of the drawings, a flow chart providing an overview of the method of advertising products in accordance with the present exemplary system and method and as described hereinabove, is shown.

The system and method of advertising products in accordance with the present exemplary system and method provides a simple yet effective means for advertising products to potential purchasers who are actively seeking to purchase products in the relevant product category.

In another example of the present system and method, the method and system for advertising information in accordance with the system and method, may be used by a retailer as part of a promotion for a certain product to customers, wherein the retailer advertises the availability of electronic discount vouchers for the product for download on a mobile device such a cell phone. The advertiser in this case will advertise the product and the electronic discount voucher in an advertisement using any suitable advertising medium. The advertisement contains a unique reference code which potential customers are required to send to the server of the system to obtain an additional piece of information on the product. In this example, the additional piece of information is in the form of the electronic discount voucher.

Upon receipt of the unique reference code from the potential customer, the server, and particularly the processor of the server, is operable to access and search the database for a unique reference code associated with an additional piece of information which matches the unique reference code supplied by the potential customer. While processing the request from the potential customer, the server is operable to select a further piece of information in the form of an advertisement of another advertiser which is stored in the database and which is related to the product being promoted by the retailer, according to a predetermined criterion. As such, while processing the request from the potential customer and waiting for the electronic discount voucher to be downloaded to the potential customer's cell phone, the advertisement of the other advertiser is sent to the cell phone of the potential customer. If the unique reference code sent by the potential customer matches the unique reference code associated with an electronic discount voucher stored on the database for the retailer, the electronic discount voucher is sent to the potential customer's cell phone using the caller identification of the potential customer's cell phone.

It will be appreciated that the criteria used by the system to select further information to end users may vary greatly and may be determined by a number of different factors.

In another example of the present system and method, the method and system for advertising information may be used by publishers of newspapers in relation to newspaper editorials. As such, a newspaper publisher may insert a unique reference code into a newspaper editorial. End users in the form of readers of the newspaper will be able to access an additional piece of information relating to the newspaper editorial by sending the unique reference code to the server of the system. Upon receipt of the unique reference code from the reader, the server is operable to search the database for a piece of additional information which is associated with a matching unique reference code. While processing the request from the reader, the server is operable to access and search the database for a further piece of information which is related, according to a predetermined criterion, to the content of the newspaper editorial and to send the further piece of information to the reader while the reader awaits the download of the additional information. Alternatively, the further piece of information may be sent to the reader shortly after the additional piece of information has been sent to the reader. Again, the additional piece of information and the further piece of information may be sent to a mobile device such as a cell phone or other wireless device of the reader. If the newspaper editorial covered a particular topic such as a rugby game, the piece of additional information may contain further information in the form of photographs, images, video clips, additional research information on the rugby game and the further piece of information may contain advertisement information offering rugby boots for sale. It will be appreciated that the pieces of information whether in the form of the advertisement information, an additional piece of information or a further piece of information may be provided in any medium including but not necessarily limited to text, still images, animated images, audio, video, coupons or vouchers.

The preceding description has provided several exemplary embodiments of a system and method for providing advertisement services. The description in conjunction with the figures provides several examples according to various exemplary embodiments; however it should be understood that many variations and modifications of the preceding description are possible and have not been described in detail due to their vast number. It will be understood that various modifications may be made without departing from the spirit and scope of the present exemplary systems and methods.

The preceding description has been presented only to illustrate and describe embodiments and examples of the principles described. This description is not intended to be exhaustive or to limit these principles to any precise form disclosed. Many modifications and variations are possible in light of the above teachings. It is intended that the scope of the exemplary system and method be defined by the following claims.

What is claimed is:

1. A method of advertising information, the method comprising:
receiving a request from an advertiser wishing to advertise certain advertisement information, to make a particular additional piece of information which is associated with said advertisement information and which is supplied by the advertiser, available to the public; and
issuing a unique reference code corresponding to the additional piece of information;
storing the additional piece of information together with the unique reference code in a database;
providing the advertiser with the unique reference code for insertion in an advertisement containing said advertisement information;
receiving a request from an end user to view the additional piece of information, which is accompanied by the unique reference code corresponding to the additional piece of information;
allowing the end user access to said additional piece of information; and
providing the end user with a further piece of information which is related to said advertisement information according to a predetermined criterion, and which is supplied by the or a different advertiser.

2. The method as claimed in claim 1, further comprising:
receiving requests from a number of different advertisers wishing to advertise different advertisement information, to make additional pieces of information available to the public; and
issuing a unique reference code corresponding to each additional piece of information.

3. The method of claim 2, further comprising:
selecting at least one further piece according to said predetermined criterion upon receipt of a request from an end user to view a particular additional piece of information which is accompanied by the unique reference code corresponding to said additional piece of information, and
providing the end user with said further piece of information.

4. The method of claim 3, further comprising:
classifying the additional pieces of information and the further pieces of information into different categories;
storing each of the additional and the further pieces of information in the database in one of the categories; and
selecting at least one further piece of information from the same category in which the requested additional piece of information is stored, upon receipt of a request from an end user to view the additional piece of information.

5. The method of claim 4, wherein the advertisement information includes information on a particular product which the advertiser wishes to sell and wherein each additional piece of information includes additional information on the product, together with contact information sufficient to enable the advertiser to be contacted, the method further comprising:
receiving a request from an end user in the form of a potential purchaser of the product, to view the additional piece of information, which is accompanied by the unique reference code corresponding to the advertisement information;
if the product is still available for sale, sending the additional piece of information to the potential purchaser; and
if the product is no longer available for sale, sending the potential purchaser at least one further piece of information on another product which is related to said product according to said predetermined criterion and which is offered for sale by the or another advertiser.

6. The method of claim 1, further comprising communicating with the advertiser and the end user via a mobile communications network.

7. The method of claim 6, further comprising communicating with the advertiser and the end user by sending and receiving messages via a mobile telecommunications network.

8. A system for advertising information, comprising:
memory means in which information can be stored;
processing means which is operable to:
receive a request from an advertiser wishing to advertise certain advertisement information, to make a particular additional piece of information which is associated with said advertisement information and which is supplied by the advertiser, available to the public; and to issue a unique reference code corresponding to the additional piece of information;
store the additional piece of information together with the unique reference code in the memory means;
provide the advertiser with the unique reference code for insertion in an advertisement containing said advertisement information;
receive a request from an end user to view the additional piece of information, which is accompanied by the unique reference code corresponding to the additional piece of information;
allow the end user access to said additional piece of information; and
provide the end user with a further piece of information which is related to said advertisement information according to a predetermined criterion and which is supplied by the or a different advertiser; and
a communications module for communication with the advertiser and end user.

9. The system of claim 8, wherein the processing means is operable to receive requests from a plurality of different advertisers each wishing to advertise different advertisement information, to make different additional pieces of information available to the public and to issue a unique reference code corresponding to each additional piece of information.

10. The system of claim 9, wherein the processing means is operable to, upon receipt of a request from an end user to view a particular additional piece of information which is accompanied by the unique reference code corresponding to said additional piece of information, select at least one further piece of information of the or another advertiser according to said predetermined criterion and to provide the end user with said further piece of information.

11. The system of claim 10, wherein the processing means is operable to classify the additional piece of information and the further pieces of information into different categories and to store each of the additional and further pieces of information in the database in one of the categories and to select at least one further piece of information from the same category in which the requested additional piece of information is stored, upon receipt of a request from an end user to view the additional piece of information.

12. The system of claim 11, wherein the advertisement information of a particular advertiser includes information on a particular product which the advertiser wishes to sell and the associated additional piece of information includes additional information on the product, together with contact information sufficient to enable the advertiser to be contacted, the processing means being operable to receive a request from an end user in the form of a potential purchaser of the product, to view the additional piece of information, which is accompanied by the unique reference code corresponding to the advertisement information; and if the product is still available for sale, to send the potential purchaser the additional piece of information; and if the product is no longer available for sale, to send the potential purchaser at least one further piece of information on another product which is related to said product according to said predetermined criterion and which is offered for sale by the or another advertiser.

13. The system of claim 8, wherein the communications module is operable to communicate with the advertiser and the end user via a mobile communications network.

14. The system of claim 13, wherein the communications module is operable to communicate with the advertiser and the end user by sending and receiving messages via a mobile telecommunications network.
